(19) United States
(12) Patent Application Publication
(10) Pub. No.: US 2025/0353216 A1
(43) Pub. Date: Nov. 20, 2025

(54) EXPANDED POLYPROPYLENE FOAM TRAY

(71) Applicant: PROAMPAC HOLDINGS INC., Cincinnati, OH (US)

(72) Inventors: Maryam Dini, Beaconsfield (CA); Pascal Labrie, Rawdon (CA)

(21) Appl. No.: 19/213,057

(22) Filed: May 20, 2025

Related U.S. Application Data
(60) Provisional application No. 63/649,667, filed on May 20, 2024.

(51) Int. Cl. B29B 7/00; B29C 48/00; B29C 48/08; B29K 23/00; B29K 105/00; B29K 509/02; B29L 31/00; B65D 1/34; C08J 3/22; C08J 9/00; C08K 3/34; C08K 5/00

(52) U.S. Cl. CPC B29B 7/002; B29C 48/0017; B29C 48/022; B29C 48/08; B65D 1/34; C08J 3/22; C08J 9/0066; C08K 3/346; C08K 5/005; B29K 2023/12; B29K 2105/0044; B29K 2509/02; B29L 2031/712; C08J 2207/00; C08J 2323/12

(57) ABSTRACT

In one aspect, a method for forming a foamable polypropylene extrusion mixture includes providing a polypropylene resin and blending a nucleating agent, a polymer stabilizer, and a physical blowing agent with the polypropylene resin. In another aspect, a method for forming a foamable polypropylene extrusion mixture includes providing a polypropylene resin and blending a nucleating agent, a polymer stabilizer, a physical blowing agent, and a chemical foaming agent with the polypropylene resin. In further aspects, a foamable polypropylene extrusion mixture and foam articles are provided. The foamable polypropylene extrusion mixtures are extrudable to form a polypropylene foam sheet or web which is thermoformable to produce a polypropylene foam packaging tray having superior rigidity and puncture resistance.

### CROSS REFERENCE TO RELATED APPLICATION

This application claims the priority benefit of U.S. Provisional Patent Application No. 63/649,667 filed May 20, 2024. The aforementioned application is incorporated herein by reference in its entirety.

### BACKGROUND

The present disclosure relates generally to the field packaging and to foamable polypropylene extrusion mixtures, methods for making the foamable polypropylene extrusion mixtures, methods for making an expanded polypropylene foam, methods form making form packaging trays, and foam trays produced thereby.

### SUMMARY

In one aspect, methods for forming foamable polypropylene (PP) extrusion mixtures are provided. In another aspect, foam articles, including thermoformed packaging trays, produced from the foamable polypropylene extrusion mixtures in accordance with this disclosure are provided.

In certain embodiments, the method for producing a foamable polypropylene extrusion mixture comprises: providing a polypropylene resin; providing a nucleating agent; providing a polymer stabilizer; and providing a physical blowing agent. In alternative embodiments, the foamable polypropylene extrusion mixture comprises: providing a polypropylene resin; providing a polymer stabilizer; providing a physical blowing agent; and providing a chemical foaming agent.

The resultant foamable polypropylene extrusion mixture is extrudable to produce expanded polypropylene foam sheets of material. In embodiments, expanded polypropylene foam sheets of material are thermoformable to produce packaging trays. In a further aspect, a method for making expanded polypropylene foam trays comprises: providing the foamable polypropylene extrusion mixture; extruding the foamable polypropylene extrusion mixture to form an expanded propylene foam sheet; thermoforming the foam sheet; and cutting the thermoformed sheets to form the expanded polypropylene foam trays. In certain embodiments, the thermoforming process comprises a vacuum or pressure forming process. In certain embodiments, the thermoforming process comprises a multi-cavity vacuum or pressure forming process, wherein multiple trays are formed simultaneously from the foam sheet. It will be recognized, however, that in certain embodiments, the sheet may be cut into individual tray blanks which are then thermoformed to form a tray, e.g., for low volume or custom production scenarios. In certain embodiments, it has been found that, in reducing the present development to practice, the resultant polypropylene foam trays exhibit excellent puncture resistance and rigidity.

Various advantages and benefits of the present invention will become apparent to those of ordinary skill in the art upon reading and understanding the following detailed description of the preferred embodiments.

### BRIEF DESCRIPTION OF THE DRAWINGS

The invention may take form in various components and arrangements of components, and in various steps and arrangements of steps. The drawings are only for purposes of illustrating preferred embodiments and are not to be construed as limiting the invention.

FIG. 1A is a flow chart illustrating the steps of a first exemplary method for forming a foamable polypropylene extrusion mixture.

FIG. 1B is a flow chart illustrating the steps of a second exemplary method for forming a foamable polypropylene extrusion mixture.

FIG. 2 is an image of an expanded polypropylene foam material formed from foamable polypropylene extrusion mixture of FIGS. 1A or 1B.

FIG. 3 is a flow chart illustrating the steps of a method for forming a polypropylene foam tray.

FIG. 4 is a bottom view of an exemplary polypropylene foam tray as formed from the method of FIG. 3.

FIG. 5 is side cross sectional view of the from the polypropylene foam tray appearing in FIG. 3.

FIG. 6 is a table comparing characteristics of a polypropylene foam tray of the present disclosure with a prior art polystyrene-based foam tray.

FIG. 7A is an image showing a defective sheet resulting from excessive polyethylene in the extrusion mixture.

FIG. 7B is an enlarged view of a defect in an extruded sheet resulting from excessive polyethylene in the extrusion mixture.

### DETAILED DESCRIPTION OF THE PREFERRED EMBODIMENTS

Reference will now be made in detail to presently preferred embodiments of the invention, one or more examples of which are illustrated in the accompanying drawings. Each example is provided by way of explanation of the invention, not limitation of the invention, which may be embodied in various forms. Therefore, specific structural and functional details disclosed herein are not to be interpreted as limiting but merely as a basis for the claims and as a representative basis for teaching one skilled in the art to variously employ the present inventive concept in virtually any appropriately detailed structure. Further, the terms and phrases used herein are not intended to be limiting but rather to provide an understandable description of the present development. In fact, it will be apparent to those skilled in the art that modifications and variations can be made in the present invention without departing from the scope or spirit thereof. For instance, features illustrated or described as part of one embodiment may be used on another embodiment to yield a still further embodiment. Thus, it is intended that the present invention covers such modifications and variations as come within the scope of the appended claims and their equivalents.

The terms “a” or “an,” as used herein, are defined as one or more than one. The term “another,” as used herein, is defined as at least a second or more. The terms “including” and/or “having” as used herein, are defined as comprising (i.e., open transition). The term “coupled” or “operatively coupled,” as used herein, is defined as indirectly or directly connected.

As used in this application, the terms “front,” “rear,” “upper,” “lower,” “upwardly,” “downwardly,” “left,” “right,” and other orientation descriptors are intended to facilitate the description of the exemplary embodiment(s) of the present invention and are not intended to limit the structure thereof to any particular position or orientation.

All numbers herein are assumed to be modified by the term “about,” unless stated otherwise. The recitation of numerical ranges by endpoints includes all numbers subsumed within that range (e.g., 1 to 5 includes 1, 1.5, 2, 2.75, 3, 3.80, 4, and 5).

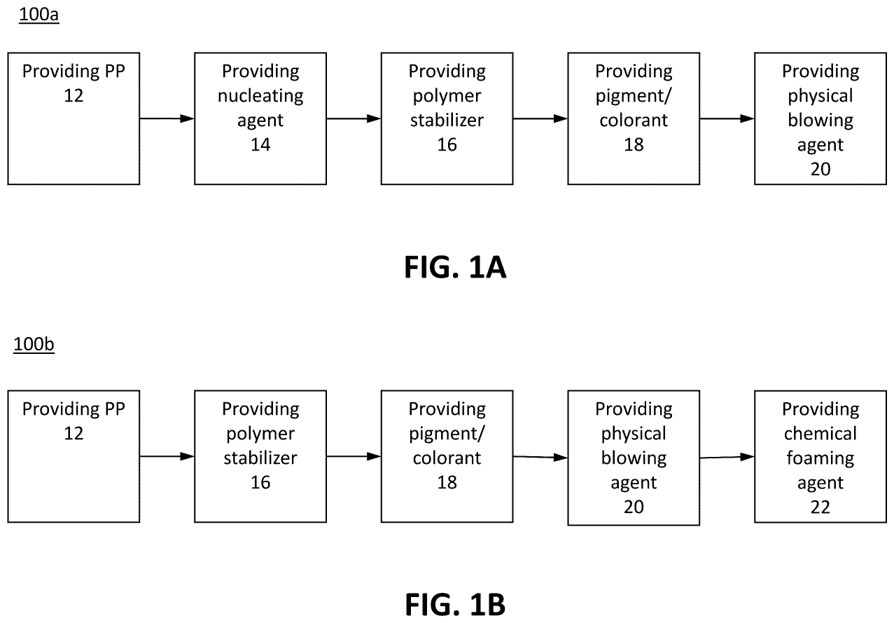

Referring first to FIG. 1A, there appears flow chart illustrating a method 100a for forming a foamable extrusion mixture, which uses only one or more physical blowing agents. The method 100a includes providing a polypropylene resin at step 12. At step 14, a nucleating agent 14 is blended with the polypropylene resin. A polymer stabilizer is blended with the polypropylene resin at step 16. At step 18, a pigment or colorant is blended with the polypropylene resin. It will be recognized that step 18 is optional and that in embodiments, the inclusion of a colorant is optional and the extrusion mixture may be produced without a colorant. At step 20, one or more physical blowing agents are blended into the extrusion mixture. In embodiments, the components may be blended in an extruder or first blended in a mixer and fed to an extruder.

In embodiments, the foamable extrusion mixture produced by the method 100a is configured to produce a resulting foam product having a maximum compressive load which is greater than or equal to 15 N and less than or equal to 100 N and a density which is in the range of from 70 kg/m³ to 200 kg/m³.

Unless specifically stated otherwise, the term “maximum compressive load” as used herein refers to the maximum compressive load measured while the foam product is compressed in the thickness direction at a compression velocity of 25 mm/min, in accordance with ASTM F1306 using a rectangular specimen at room temperature. In embodiments, the maximum compressive load is measured using an Instron E3000 device in accordance with ASTM F1306.

In certain embodiments, the foamable extrusion mixture produced by the method 100a is configured to produce foam which have a maximum compressive load in the range of from about 15 N to about 100 N, preferably from about 25 N to about 60 N, and more preferably from about 30 N to about 55 N, e.g., 15 N, 16 N, 17 N, 18 N, 19 N, 20 N, 21 N, 22 N, 23 N, 24 N, 25 N, 26 N, 27 N, 28 N, 29 N, 30 N, 31 N, 32 N, 33 N, 34 N, 35 N, 36 N, 37 N, 38 N, 39 N, 40 N, 41 N, 42 N, 43 N, 44 N, 45 N, 46 N, 47 N, 48 N, 49 N, 50 N, 51 N, 52 N, 53 N, 54 N, 55 N, 56 N, 57 N, 58 N, 59 N, 60 N, 61 N, 62 N, 63 N, 64 N, 65 N, 66 N, 67 N, 68 N, 69 N, 70 N, 71 N, 72 N, 73 N, 74 N, 75 N, 76 N, 77 N, 78 N, 79 N, 80 N, 81 N, 82 N, 83 N, 84 N, 85 N, 86 N, 87 N, 88 N, 89 N, 90 N, 91 N, 92 N, 93 N, 94 N, 95 N, 96 N, 97 N, 98 N, 99 N, or 100 N.

In certain embodiments, foamable extrusion mixture produced by the method 100a is configured to produce foam articles having a density in the range of from 70 kg/m3 to about 200 kg/m³, preferably from about 100 kg/m³ about 175 kg/m³, and more preferably from about 125 kg/m³ to about 150 kg/m³, e.g., about 70 kg/m³, 71 kg/m³, 72 kg/m³, 73 kg/m³, 74 kg/m³, 75 kg/m³, 76 kg/m³, 77 kg/m³, 78 kg/m³, 79 kg/m³, 80 kg/m³, 81 kg/m³, 82 kg/m³, 83 kg/m³, 84 kg/m³, 85 kg/m³, 86 kg/m³, 87 kg/m³, 88 kg/m³, 89 kg/m³, 90 kg/m³, 91 kg/m³, 92 kg/m³, 93 kg/m³, 94 kg/m³, 95 kg/m³, 96 kg/m³, 97 kg/m³, 98 kg/m³, 99 kg/m³, 100 kg/m³, 100 kg/m³, 101 kg/m³, 102 kg/m³, 103 kg/m³, 104 kg/m³, 105 kg/m³, 106 kg/m³, 107 kg/m³, 108 kg/m³, 109 kg/m³, 110 kg/m³, 111 kg/m³, 112 kg/m³, 113 kg/m³, 114 kg/m³, 115 kg/m³, 116 kg/m³, 117 kg/m³, 118 kg/m³, 119 kg/m³, 120 kg/m³, 121 kg/m³, 122 kg/m³, 123 kg/m³, 124 kg/m³, 125 kg/m³, 126 kg/m³, 127 kg/m³, 128 kg/m³, 129 kg/m³, 130 kg/m³, 131 kg/m³, 132 kg/m³, 133 kg/m³, 134 kg/m³, 135 kg/m³, 136 kg/m³, 137 kg/m³, 138 kg/m³, 139 kg/m³, 140 kg/m³, 140 kg/m³, 141 kg/m³, 142 kg/m³, 143 kg/m³, 144 kg/m³, 145 kg/m³, 146 kg/m³, 147 kg/m³, 148 kg/m³, 149 kg/m³, 150 kg/m³, 151 kg/m³, 152 kg/m³, 153 kg/m³, 154 kg/m³, 155 kg/m³, 156 kg/m³, 157 kg/m³, 158 kg/m³, 159 kg/m³, 160 kg/m³, 161 kg/m³, 162 kg/m³, 163 kg/m³, 164 kg/m³, 165 kg/m³, 166 kg/m³, 167 kg/m³, 168 kg/m³, 169 kg/m³, 170 kg/m³, 171 kg/m³, 172 kg/m³, 173 kg/m³, 174 kg/m³, 175 kg/m³, 176 kg/m³, 177 kg/m³, 178 kg/m³, 179 kg/m³, 180 kg/m³, 181 kg/m³, 182 kg/m³, 183 kg/m³, 184 kg/m³, 185 kg/m³, 186 kg/m³, 187 kg/m³, 188 kg/m³, 189 kg/m³, 190 kg/m³, 191 kg/m³, 192 kg/m³, 193 kg/m³, 194 kg/m³, 195 kg/m³, 196 kg/m³, 197 kg/m³, 198 kg/m³, 199 kg/m³, or 200 kg/m³.

In embodiments, the polypropylene resin is a polypropylene homopolymer resin comprising a virgin polypropylene resin or a recycled polypropylene resin, in each case having a melt flow index (MFI) or melt flow rate (MFR) in the range of about 1 g/10 min to about 20 g/10 min, preferably in the range of from about 1.5 g/10 min to about 10 g/10 min. Unless specified otherwise, all MFI values herein are measured according to ISO 1133 at a temperature of 230° C. and 2.16 kg load. In embodiments, the polypropylene extrusion mixture comprises 70-90% polypropylene resin. All compositional percentages provided herein are by weight, unless specifically stated otherwise.

As would be understood by persons skilled in the art, the nucleating agent added at step 14 promotes the formation of small, uniform gas bubbles. In embodiments, the nucleating agent provided at step 14 is added to the extrusion mixture in the form of a nucleating agent masterbatch comprising the nucleating agent dispersed at high concentration in a carrier resin. The masterbatch composition, in turn, is blended with the polypropylene resin to ensure uniform distribution.

In embodiments, the nucleating agent is talc and is introduced into the extrusion mixture in a talc masterbatch composition comprising talc in a carrier resin matrix, such as a polyolefin matrix. In embodiments, the masterbatch composition comprises about 40-80% talc content based on the weight of the masterbatch composition. In embodiments, the talc masterbatch composition comprises about 50-70% talc content based on the weight of the masterbatch composition. In embodiments, the masterbatch composition comprises about 40-80% talc content based on the weight of the carrier resin matrix. In embodiments, the talc masterbatch composition comprises about 50-70% talc content based on the weight of the carrier resin matrix.

In embodiments, the nucleating agent masterbatch carrier resin comprises a polyolefin, such as polyethylene or polypropylene resin. In embodiments, the talc masterbatch composition is added to the polypropylene extrusion mixture in an amount sufficient to yield about 2-6% talc by weight based on the weight of the final foam sheet. In embodiments, the talc masterbatch composition is added to the polypropylene extrusion mixture in an amount sufficient to yield about 3-5% talc by weight based on the weight of the final foam sheet. In embodiments, the talc masterbatch composition is added to the polypropylene extrusion mixture in an amount sufficient to yield about 4% talc masterbatch by weight based on the weight of the final foam sheet.

In embodiments, the polymer stabilizer provided at step 16 is likewise added to the extrusion mixture in the form of a stabilizer masterbatch composition comprising a stabilizer dispersed in a carrier resin matrix. In embodiments, the stabilizer is an antioxidant. The antioxidant may be any suitable antioxidant for decreasing thermal oxidative degradation of the polypropylene resin during the foaming process, as well as during a subsequent recycling process. In embodiments, the stabilizer is introduced into the extrusion mixture in a stabilizer masterbatch composition comprising about 5-20% stabilizer by weight in a carrier resin. In embodiments, the stabilizer masterbatch carrier resin comprises a polyolefin, such as polyethylene or polypropylene resin. In embodiments, the stabilizer/antioxidant masterbatch composition is added to the polypropylene extrusion mixture in an amount ranging from about 0.9% to about 1.0% based on the weight of the polypropylene extrusion mixture. In embodiments, the concentration of the stabilizer/antioxidant in the stabilizer masterbatch composition is sufficient to yield a stabilizer concentration of approximately 1000 ppm based on the weight of the final foam product. In embodiments, the stabilizer/antioxidant masterbatch yields better results when an extrusion grade polypropylene resin is used as the stabilizer masterbatch carrier matrix.

In embodiments, the antioxidant stabilizer is pentaerythritol tetrakis(3-(3,5-di-tert-butyl-4-hydroxyphenyl)propionate), such as that sold under the trademark IRGANOX®, e.g., IRGANOX® 1010. In embodiments, the antioxidant stabilizer is tris(2,4-di-tert-butylphenyl) phosphite, such as that sold under the trademark IRGAFOS®, e.g., IRGAFOS® 168. In certain embodiments, the stabilizer/antioxidant masterbatch carrier resin is an extrusion grade polypropylene resin.

In embodiments, the pigment or colorant provided at step 18 is optionally added to the extrusion mixture in the form of a pigment/colorant masterbatch composition comprising a pigment or colorant dispersed in a carrier resin matrix. In embodiments, the carrier resin comprises a polyolefin resin. In certain embodiments, the pigment or colorant comprises brown color particles; however, it will be understood that any suitable pigment or colorant may be used, depending on the desired finished appearance of the foam product. In embodiments, the pigment or colorant is introduced into the extrusion mixture in a stabilizer masterbatch composition comprising about 6-7% pigment or colorant by weight in a carrier resin. In embodiments, the pigment/colorant carrier resin comprises a polyolefin, such as polyethylene or polypropylene resin. In embodiments, the pigment/colorant masterbatch composition is added to the polypropylene extrusion mixture in an amount ranging from about 0% to about 1.0% based on the weight of the polypropylene extrusion mixture.

In embodiments, the physical blowing agent provided at step 20 comprises a hydrocarbon blowing agent, such as a lower alkane, e.g., isobutane, isopentane, or a mixture thereof. In embodiments, carbon dioxide may also be added as a blowing agent to the extrusion mixture. In embodiments the hydrocarbon physical blowing agent comprises about 2.5% to about 5% by weight based on the weight of the polypropylene extrusion mixture, and more preferably about 3-4.8% by weight based on the weight of the polypropylene extrusion mixture. In embodiments, the carbon dioxide physical blowing agent, when included, comprises about 0% to about 1% based on the weight of the polypropylene extrusion mixture.

In embodiments, it has been found that the polypropylene foam trays produced with the extrusion mixture in accordance with this disclosure are more rigid than traditional polystyrene foam trays. In embodiments, it has been found that the polypropylene foam trays produced with the extrusion mixture in accordance with this disclosure have less residual physical blowing agent remaining in the final product than traditional polystyrene foam trays.

Now referring to FIG. 1B, a flow chart illustrating the steps of a second exemplary method 100b for forming a polypropylene foam extrusion mixture is provided. The method 100b includes a step 12 of providing a polypropylene resin. At step 16, a polymer stabilizer is blended with the polypropylene resin. At step 18, a pigment or colorant is blended with the polypropylene resin. It will be recognized that step 18 is optional and that in embodiments, the inclusion of a colorant is optional and the extrusion mixture may be produced without a colorant. At step 20, one or more physical blowing agents are blended into the extrusion mixture. At step 22, a chemical foaming agent is blended into the extrusion mixture. In embodiments, the components may be blended in an extruder or first blended in a mixer and fed to an extruder.

In embodiments, the foamable extrusion mixture produced by the method 100b is configured to produce a resulting foam product having a maximum compressive load which is greater than or equal to 15 N and less than or equal to 100 N at room temperature and a density which is greater than or equal to 70 kg/m³ and less than 150 kg/m³.

In certain embodiments, the foamable extrusion mixture produced by the method 100b is configured to produce foam which have a maximum compressive load in the range of from about 15 N to about 100 N, preferably from about 25 N to about 60 N, and more preferably from about 30 N to about 55 N, e.g., 15 N, 16 N, 17 N, 18 N, 19 N, 20 N, 21 N, 22 N, 23 N, 24 N, 25 N, 26 N, 27 N, 28 N, 29 N, 30 N, 31 N, 32 N, 33 N, 34 N, 35 N, 36 N, 37 N, 38 N, 39 N, 40 N, 41 N, 42 N, 43 N, 44 N, 45 N, 46 N, 47 N, 48 N, 49 N, 50 N, 51 N, 52 N, 53 N, 54 N, 55 N, 56 N, 57 N, 58 N, 59 N, 60 N, 61 N, 62 N, 63 N, 64 N, 65 N, 66 N, 67 N, 68 N, 69 N, 70 N, 71 N, 72 N, 73 N, 74 N, 75 N, 76 N, 77 N, 78 N, 79 N, 80 N, 81 N, 82 N, 83 N, 84 N, 85 N, 86 N, 87 N, 88 N, 89 N, 90 N, 91 N, 92 N, 93 N, 94 N, 95 N, 96 N, 97 N, 98 N, 99 N, or 100 N.

In certain embodiments, foamable extrusion mixture produced by the method 100b is configured to produce foam articles having a density in the range of from 70 kg/m³ to about 200 kg/m³, preferably from about 100 kg/m³ about 175 kg/m³, and more preferably from about 125 kg/m³ to about 150 kg/m³, e.g., about 70 kg/m³, 71 kg/m³, 72 kg/m³, 73 kg/m³, 74 kg/m³, 75 kg/m³, 76 kg/m³, 77 kg/m³, 78 kg/m³, 79 kg/m³, 80 kg/m³, 81 kg/m³, 82 kg/m³, 83 kg/m³, 84 kg/m³, 85 kg/m³, 86 kg/m³, 87 kg/m³, 88 kg/m³, 89 kg/m³, 90 kg/m³, 91 kg/m³, 92 kg/m³, 93 kg/m³, 94 kg/m³, 95 kg/m³, 96 kg/m³, 97 kg/m³, 98 kg/m³, 99 kg/m³, 100 kg/m³, 100 kg/m³, 101 kg/m³, 102 kg/m³, 103 kg/m³, 104 kg/m³, 105 kg/m³, 106 kg/m³, 107 kg/m³, 108 kg/m³, 109 kg/m³, 110 kg/m³, 111 kg/m³, 112 kg/m³, 113 kg/m³, 114 kg/m³, 115 kg/m³, 116 kg/m³, 117 kg/m³, 118 kg/m³, 119 kg/m³, 120 kg/m³, 121 kg/m³, 122 kg/m³, 123 kg/m³, 124 kg/m³, 125 kg/m³, 126 kg/m³, 127 kg/m³, 128 kg/m³, 129 kg/m³, 130 kg/m³, 131 kg/m³, 132 kg/m³, 133 kg/m³, 134 kg/m³, 135 kg/m³, 136 kg/m³, 137 kg/m³, 138 kg/m³, 139 kg/m³, 140 kg/m³, 140 kg/m³, 141 kg/m³, 142 kg/m³, 143 kg/m³, 144 kg/m³, 145 kg/m³, 146 kg/m³, 147 kg/m³, 148 kg/m³, 149 kg/m³, 150 kg/m³, 151 kg/m³, 152 kg/m³, 153 kg/m³, 154 kg/m³, 155 kg/m³, 156 kg/m³, 157 kg/m³, 158 kg/m³, 159 kg/m³, 160 kg/m³, 161 kg/m³, 162 kg/m³, 163 kg/m³, 164 kg/m³, 165 kg/m³, 166 kg/m³, 167 kg/m³, 168 kg/m³, 169 kg/m³, 170 kg/m³, 171 kg/m³, 172 kg/m³, 173 kg/m³, 174 kg/m³, 175 kg/m³, 176 kg/m³, 177 kg/m³, 178 kg/m³, 179 kg/m³, 180 kg/m³, 181 kg/m³, 182 kg/m³, 183 kg/m³, 184 kg/m³, 185 kg/m³, 186 kg/m³, 187 kg/m³, 188 kg/m³, 189 kg/m³, 190 kg/m³, 191 kg/m³, 192 kg/m³, 193 kg/m³, 194 kg/m³, 195 kg/m³, 196 kg/m³, 197 kg/m³, 198 kg/m³, 199 kg/m³, or 200 kg/m³.

In embodiments, the polypropylene resin is a polypropylene homopolymer resin comprising a virgin polypropylene resin or a recycled polypropylene resin, in each case having a melt flow index (MFI) or melt flow rate (MFR) in the range of about 1 g/10 min to about 20 g/10 min, preferably in the range of from about 1.5 g/10 min to about 10 g/10 min. In embodiments, the polypropylene extrusion mixture comprises 70-95% polypropylene resin. All compositional percentages provided herein are by weight, unless specifically stated otherwise.

In embodiments, the polypropylene resin provided at step 12 is a polypropylene homopolymer resin comprising a virgin polypropylene resin or a recycled polypropylene resin, in each case having a melt flow index (MFI) of 1-20 g/10 min, preferably 1.5-10 g/10 minutes (230° C. and 2.16 kg) measured according to ISO 1133. In embodiments, the polypropylene foam extrusion mixture is 70-95% polypropylene.

In embodiments, the polymer stabilizer provided at step 16 in FIG. 1B is as described above by way of reference to the method 100a appearing in FIG. 1A. In embodiments, the polymer stabilizer provided at step 16 in FIG. 1B is added in a quantity and masterbatch formulation as described above by way of reference to the method 100a appearing in FIG. 1A.

In embodiments, the colorant or pigment provided at step 18 in FIG. 1B is as described above by way of reference to the method 100a appearing in FIG. 1A. In embodiments, the colorant or pigment provided at step 18 in FIG. 1B is added in a quantity and masterbatch formulation as described above by way of reference to the method 100a appearing in FIG. 1A.

In embodiments, the physical blowing agent(s) provided at step 20 are the same as the physical blowing agent(s) described above by way of reference to FIG. 1A and are added in comparable quantities as described in reference to FIG. 1A above, unless explicitly stated otherwise.

In embodiments, the chemical foaming agent provided at step 22 is added to the extrusion mixture in the form of a masterbatch formulation comprising about 20% to about 60% of an active chemical foaming agent dispersed in a polyolefin matrix, preferably about 30% to about 50%, and more preferably about 40%, based on the weight of the masterbatch formulation. The masterbatch composition is added to the extrusion mixture in an amount ranging from 0% to about 2% based on the weight of the extrusion mixture.

In certain embodiments, the chemical foaming agent is an endothermic chemical foaming agent. In alternative embodiments, exothermic chemical foaming agents are also contemplated. In certain embodiments, the chemical foaming agent may be an endothermic chemical foaming agent as described in, for example, in international patent publications WO 2017/055330, which is incorporated herein by reference in its entirety. In certain embodiments, the chemical foaming agent may be, for example, a diazenedicarboxamide such as azodicarbonamide, a carbonate salt and/or bicarbonate salt.

In the extrusion mixtures described herein, the primary resin component is polypropylene. However, certain additives such as the nucleating agent, stabilizer/antioxidant, pigment/colorant, and chemical foaming agent which are added to the extrusion mixture as a masterbatch composition which may comprise a carrier resin formed of a polyolefin other than polypropylene, such as polyethylene, such as low density polyethylene (LDPE), linear low density polyethylene (LLDPE), and others, propylene-ethylene copolymers (including without limitation random copolymers and block copolymers), or blends of polypropylene which contain polyethylene. It has been found that to maintain processability of the extrusion mixtures herein, the total quantity of ethylene-derived polymer content, including ethylene in polyethylene homopolymers such as LDPE, LLDPE, and others, as well as ethylene units incorporated in copolymers with propylene in the extrusion mixture should be 3% by weight or less, and more preferably 2% by weight or less based on the total weight of the extrusion mixture.

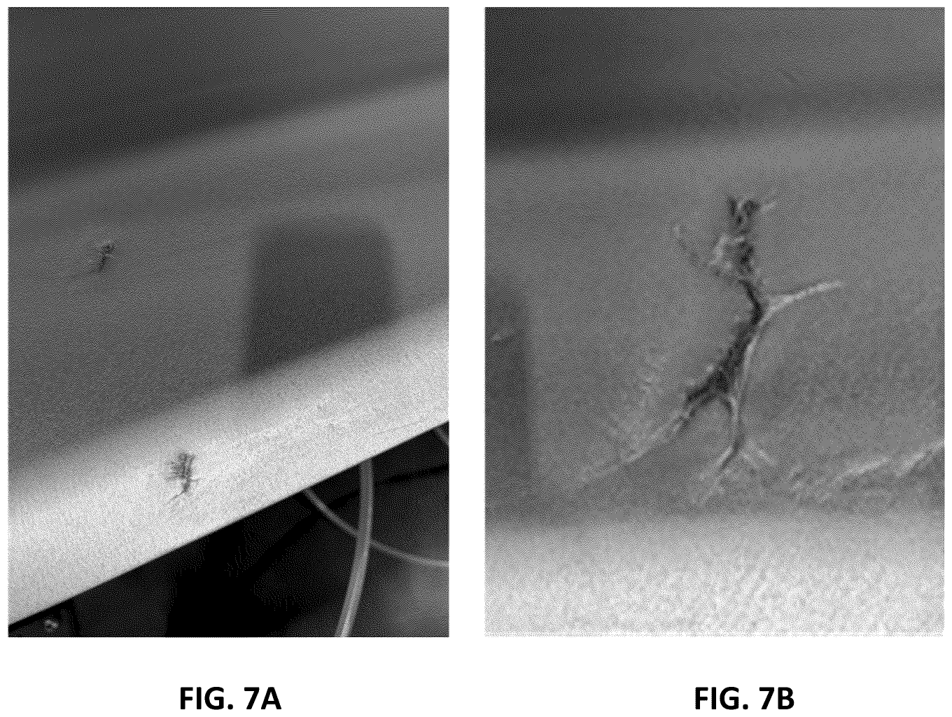

It has been found that when the total amount of ethylene-derived polymer content exceeds 3% by weight of the total weight of the extrusion mixture, solidified chunks tend to form on the outside of the die, which then stick to the sheet, as well as causing the sheet to stick to the extruder when exiting the extruder. Examples of such defects are shown in FIGS. 7A and 7B. While not intending to be bound by any particular theory, it is believed that such processing issues are the result of faster crystallization of formulations containing 3% by weight or more of ethylene-derived polymer content due to the lower crystallization temperature of polyethylene as compared to polypropylene. By limiting the quantity of ethylene derived polymer content in the extrusion mixture to 3% or less by weight of the extrusion mixture, and more preferably 2% or less by weight of the extrusion mixture, it has been found that the aforementioned processing problems can be reduced or eliminated.

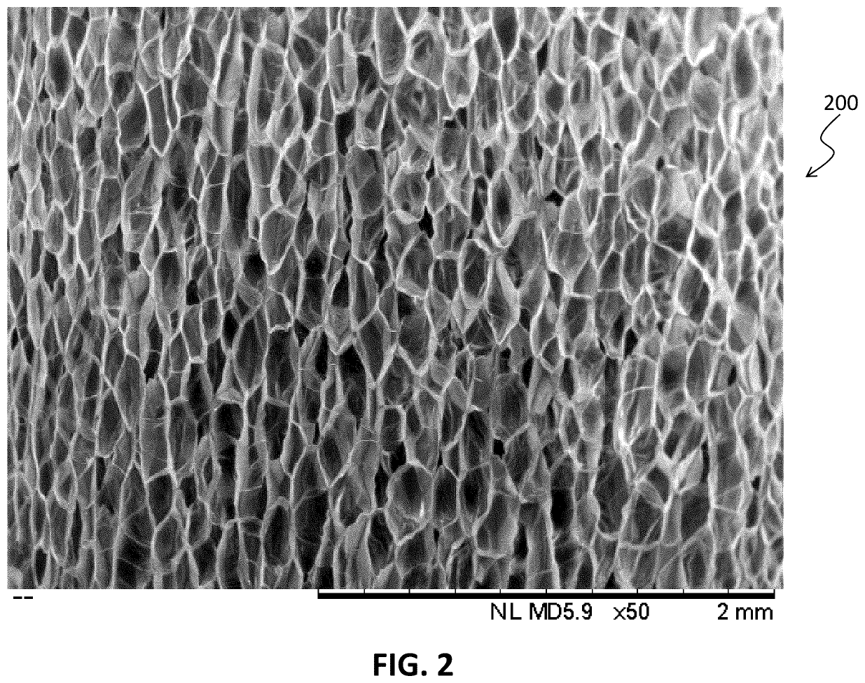

Now referring to FIG. 2, there appears a magnified image of a polypropylene foam tray 200 representative of the trays formed from the method 100a or 100b. The methods 100a and 100b affect the density and thickness of the resultant polypropylene extrusion mixture, such that a molded sheet formed therefrom has a desirable coefficient of friction, good puncture resistance, and good cuttability.

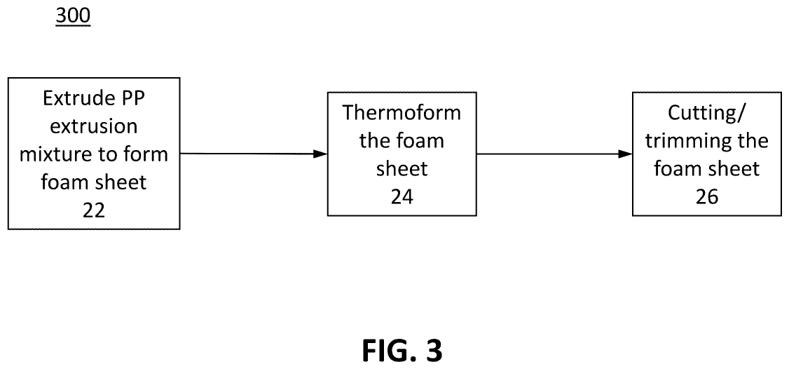

Now referring to FIG. 3, there is shown a flow chart illustrating the steps of an exemplary method 300 for forming a polypropylene foam tray. At step 22, a polypropylene extrusion mixture in accordance with the present disclosure is provided and extruded through a die to form a continuous web or sheet of expanded polypropylene foam material. In embodiments, the web is wound onto rolls for storage and off-gassing and later conversion to foam packaging trays. Alternatively, the extruded foam web passed to a tray forming station in a continuous process.

The formed foam web or sheet is then conveyed to a tray forming station comprising a plurality of mold cavities corresponding to the desired tray dimensions, either from a roll of the foam web material in a batch process, or, directly from the extrusion station in a continuous or in-line process. At the tray forming station at step 24, the trays are formed using a vacuum or pressure thermoforming process, where the foam material is softened and shaped to conform to the contours of the mold cavities.

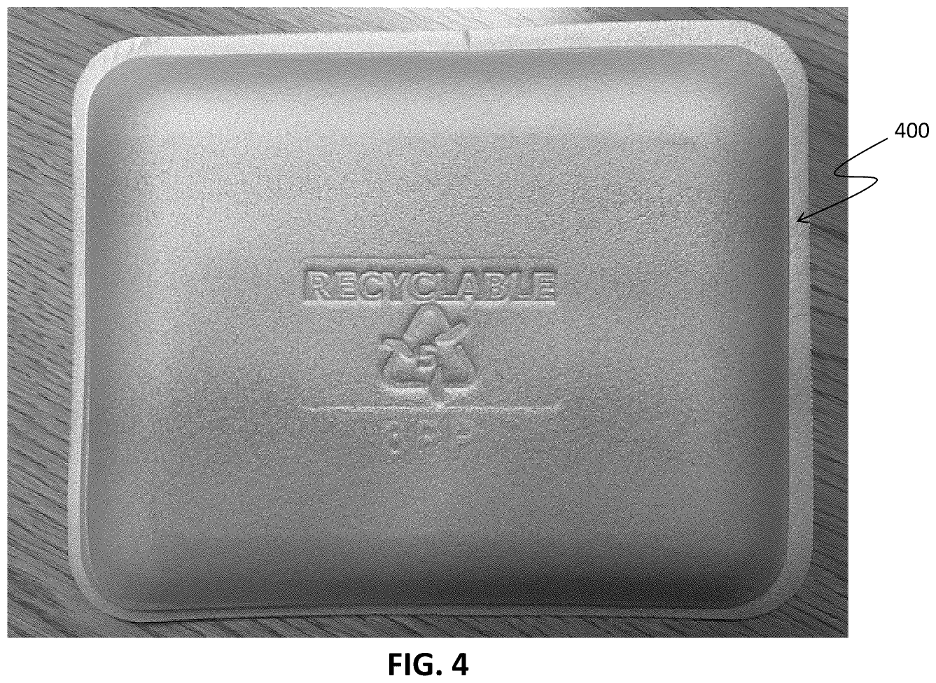

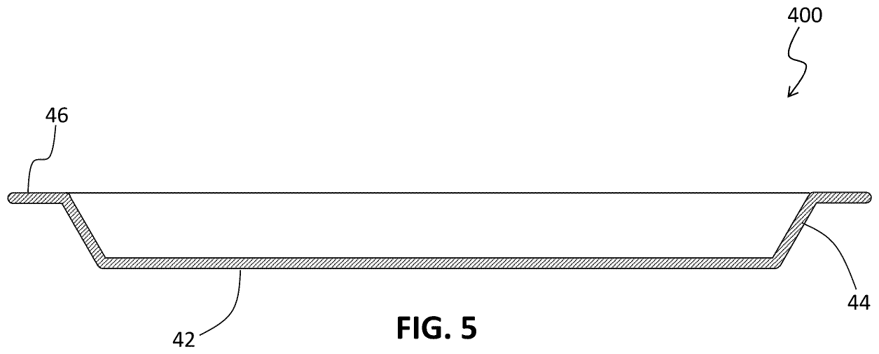

After the trays are formed, the web portion with the formed trays is conveyed to a cutting station where the trays are separated from the web by cutting at step 26. The cutting process may be performed using mechanical blades, laser cutting, punch and die or other suitable cutting technique. It has been found that the foam sheet material produced in accordance with this disclosure have good cuttability, even with traditional cutting methods such as with serrated blade cutting technology. In certain embodiments, the foam sheets produced in accordance with this disclosure have a thickness in the range of from about between 90 mil and 180 mil and good puncture resistance and moldability. Once the trays are removed from the web, the remaining waste portion of the web may be shredded and recycled. In embodiments, the remaining waste portion may be reintroduced into the extrusion process. An exemplary foam tray 400 produced in accordance with the present disclosure appears in FIGS. 4 and 5.

With reference now to FIG. 4, the tray 400 includes a base 42 bounded by an upstanding peripheral wall 44. The upper edge of the wall 44 includes a peripheral flange 46. The tray 400 is advantageous used as a packaging tray for meat and other food products, although it will be recognized that other packaging applications and configurations are also contemplated.

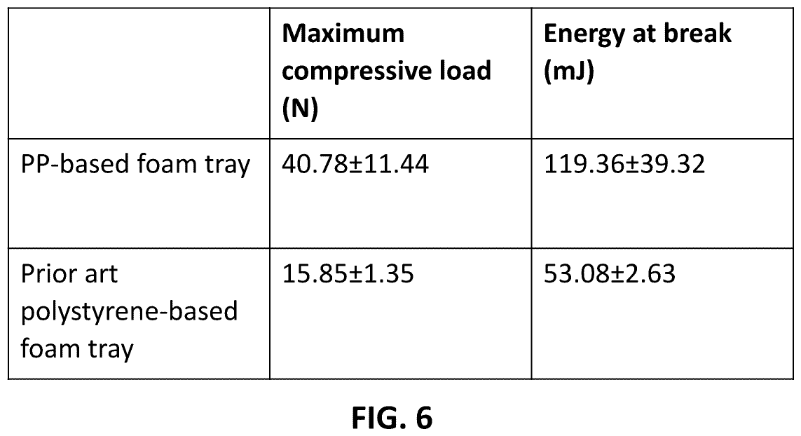

Now referring to FIG. 6, a table comparing the polypropylene-based foam tray 400 with a prior art polystyrene-based foam tray is provided. The polypropylene-based foam tray 400 in accordance with the present disclosure has a maximum compressive load of 40.78±11.44 N, as compared with the prior art polystyrene-based foam tray with a maximum compressive load of 15.85±1.35 N. The energy at break for the polypropylene-based foam tray 400, which corresponds to the total energy absorbed by the specimen is 119.36±39.32 mJ, as compared to 53.08±2.63 mJ for the prior art polystyrene-based foam tray. Energy at break was recorded during the compressive load test (per ASTM F1306) under the conditions as described above. As such, the polypropylene-based foam 400 of the present disclosure exhibits superior rigidity and puncture resistance as compared to the prior art polystyrene tray.

The invention has been described with reference to the preferred embodiments. Modifications and alterations will occur to others upon a reading and understanding of the preceding detailed description. It is intended that the invention be construed as including all such modifications and alterations insofar as they come within the scope of the appended claims or the equivalents thereof.

1. A method for forming a foamable polypropylene extrusion mixture, comprising:
providing a polypropylene resin;
heating the polypropylene resin and blending a nucleating agent into the polypropylene resin;
blending a polymer stabilizer into the polypropylene resin;
blending a physical blowing agent into the polypropylene resin;
wherein the foamable polypropylene extrusion mixture is configured to produce a foam article having a maximum compressive load which is greater than or equal to 15 N and less than or equal to 100 N; and
wherein a total amount of ethylene-derived polymer content in the extrusion mixture is less than or equal to 3% by weight.

2. The method of claim 1, wherein the polypropylene resin is selected from the group consisting of a virgin polypropylene homopolymer resin and a recycled polypropylene homopolymer resin.

3. The method of claim 1, wherein the foamable polypropylene extrusion mixture comprises from 70% to 95% of the polypropylene resin.

4. The method of claim 1, wherein the polypropylene resin has a melt flow index (MFI), measured at 230° C. and 2.16 kg according to ISO 1133, of between 1 g/10 min and 20 g/10 min.

5. The method of claim 1, wherein the nucleating agent comprises talc.

6. The method of claim 5, wherein the talc is added to the foamable polypropylene extrusion mixture in a talc masterbatch composition comprising talc particles dispersed in a carrier resin.

7. The method of claim 6, further comprising one or both of:
wherein the carrier resin comprises a polyolefin resin and the talc masterbatch composition comprises 40-80% talc by weight; and
wherein the talc masterbatch composition is added to the foamable polypropylene extrusion mixture in an amount that yields a weight percentage of talc in the foam sheet in the range of 2% to 6%.

8. (canceled)

9. The method of claim 1, wherein the polymer stabilizer is selected from the group consisting of: an antioxidant; an antioxidant masterbatch composition comprising the antioxidant dispersed in a carrier resin; and an antioxidant masterbatch composition added to the foamable polypropylene extrusion mixture in an amount ranging from 0.9-1.0% by weight.

10. (canceled)

11. (canceled)

12. The method of claim 9, wherein the antioxidant masterbatch composition is added to the foamable polypropylene extrusion mixture in an amount that yields a concentration of the antioxidant in the foam article of about 1000 ppm by weight.

13. The method of claim 9, wherein the antioxidant is selected from the group consisting of pentaerythritol tetrakis(3-(3,5-di-tert-butyl-4-hydroxyphenyl)propionate) and tris(2,4-di-tert-butylphenyl) phosphite and wherein the carrier resin is an extrusion grade polypropylene resin.

14. The method of claim 1, wherein the physical blowing agent is selected from the group consisting of isobutane; isopentane; carbon dioxide; isobutane, isopentane, or a combination thereof in an amount ranging from about 2.5% to about 5% by weight; carbon dioxide in an amount ranging from 0% to about 1% by weight; and any combination of the foregoing.

15. (canceled)

16. The foamable polypropylene extrusion mixture produced by the method of claim 1.

17. A product produced from the foamable polypropylene extrusion mixture of claim 16, wherein the product is selected from the group consisting of:
a foam sheet; and
a thermoformed foam tray.

18. (canceled)

19. The product of claim 17, wherein the product is a thermoformed foam tray having a maximum compressive load in a range of about 15 N to about 60 N and a density in a range of about 70 kg/m³ to about 200 kg/m³.

20. (canceled)

21. The method of claim 1, further comprising:
blending a chemical foaming agent into the polypropylene resin.

22. The method of claim 21, wherein the chemical foaming agent is added to the foamable polypropylene extrusion mixture in a chemical foaming agent masterbatch formulation comprising an endothermic chemical foaming agent dispersed in a carrier resin.

23. The method of claim 21, wherein the carrier resin comprises a polyolefin resin and wherein the chemical foaming agent masterbatch composition comprises about 20% to about 60% by weight of one or more active endothermic chemical foaming agents.

24. The method of claim 23, wherein the chemical foaming agent masterbatch composition is added to the foamable polypropylene extrusion mixture in an amount ranging from about 1% to about 2% by weight.

25. The method of claim 1, further comprising:
extruding the foamable polypropylene extrusion mixture using an extruder to form a foam web;
thermoforming one or more foam trays from the foam web; and
cutting the foam web to separate the one or more foam trays from the foam web.

26. A foamable polypropylene extrusion mixture, comprising:
a polypropylene resin;
a nucleating agent;
a polymer stabilizer; and
a physical blowing agent;
wherein the foamable polypropylene extrusion mixture is configured to produce a foam article having a maximum compressive load which is greater than or equal to 15 N and less than or equal to 100 N; and
wherein a total amount of ethylene-derived polymer content in the extrusion mixture is less than or equal to 3% by weight.

27. A method for forming a polypropylene foam tray, comprising:
providing a foamable polypropylene extrusion mixture, the foamable polypropylene extrusion mixture comprising:
a polypropylene resin;
a nucleating agent;
a polymer stabilizer; and
a physical blowing agent;
extruding the foamable polypropylene extrusion mixture to form a foam web;
thermoforming the foam web to form one or more foam trays; and
cutting the one or more foam trays from the foam web;
wherein the foam tray has a maximum compressive load which is greater than or equal to 15 N and less than or equal to 100 N; and
wherein a total amount of ethylene-derived polymer content in the extrusion mixture is less than or equal to 3% by weight.

28. The method of claim 27, wherein the foam web has a thickness in the range of from about 90 mil to about 180 mil.

29. (canceled)
